(19) United States
(12) Patent Application Publication
(10) Pub. No.: US 2007/0113674 A1
(43) Pub. Date: May 24, 2007

(54) Systems of measuring, recording and evaluating the deformation and/or wear of structures and positioning with respect of their axis

(76) Inventor: Hugo E. Rodriguez, Montevideo (UY)

Correspondence Address: DEFILLO & ASSOCIATES, INC., P.O. Box 14104, Clearwater, FL, 33766, US

(21) Appl. No.: 11/270,737

(22) Filed: Nov. 9, 2005

(51) Int. Cl. G01N 3/20

(52) U.S. Cl. 73/849

(57) ABSTRACT

A system for measuring, recording, and evaluating a deformation and/or wear of structures and positioning the structures with respect of their axis. The system includes at least one sensor for measuring a vector with respect of planes X and Y. The sensor evaluates a point of a form of the structure. The at least one sensor interacts synchronically with a software to integrate a data from the at least one sensor to reveal the form of the structure. Then, the at least one sensor evaluates and records the deformation of the structure in order to draw its form.

### BACKGROUND OF THE INVENTION

1. Field of the Invention

This invention relates to a system for measuring, recording and further evaluating the deformation and/or wear, which for various environmental factors of contour, or mechanical and/or physical ones, are produced in relation to structures and their positioning with respect of their axis.

2. Description of Related Art

Considering the environmental factors of contour and/or mechanical and/or physical factors to which the different structures used by man are exposed, there is the need to evaluate the strains in such structures, be static or in movement and therefore, the deformations caused by them.

For such purpose, there are procedures in the state of the art that have been developed to measure punctually the deformations of the structure, by means of cells that punctually measure (strength gage) the deformation of fibers in the material composing the structure, because if we know the proportionality between the resistance to deformation and the strain causing it, we know the strains undergone by the material and its deformation.

Other methods in the state of the art allow to measure the deformations of structures by optical means, mainly through laser technology (laser alignment), which allows to draw a line in the space and further to evaluate the movement of this line which shall be proportional to the deformation.

In the consulted literature on this subject, it was found that in cases of deformations of soils or concrete structures (geo inclinometer), pendulums are used being inserted inside the structure, and when this structure moves, the sensor attached to it, records this movement (e.g. seismic recordings).

Although all these methods or systems, carry out their function of measuring and detection, in structures that are in movement, measuring and evaluation of the form is complex according to the size of the structure, and considering the costs, they are far from being cost-effective, being the real detection difficult, because they imply the use or installation of a large number of sensors, and further subject to a significant component of simulation in the representation of the form.

### SUMMARY OF THE INVENTION

This invention relates to a system for measuring, recording and further evaluating the deformation and/or wear, which for various environmental factors of contour, or mechanical and/or physical ones, are produced in relation to structures. and their positioning with respect of their axis.

The present invention concerns a system for measuring, recording, and evaluating a deformation and/or wear of structures and positioning the structures with respect of their axis, the system comprising:

at least one sensor for measuring a vector with respect of planes X and Y, wherein the sensor evaluates a point of a form of the structure;

wherein the at least one sensor is placed over he structure;

wherein the at least one sensor interacts synchronically with a software to integrate a data from the at least one sensor to reveal the form of the structure; and

wherein the at least one sensor evaluates and records the deformation of the structure in order to draw its form.

In addition, the present invention concerns a method for measuring, recording, and evaluating a deformation and/or wear of structures and positioning the structures with respect of their axis, the method comprising:

providing a system including at least one sensor;

wherein the at least one sensor is placed over he structure;

for measuring a vector with respect of planes X and Y, wherein the sensor evaluates a point of a form of the structure;

interacting synchronically the at least one sensor with a software to integrate a data from the at least one sensor to reveal the form of the structure; and

evaluating and recording the deformation of the structure in order to draw its form by measuring an angle between the original plane and the new position.

The foregoing detailed description shows that the preferred embodiments of the present invention are well suited to fulfill the objects of the invention. It is recognized that those skilled in the art may make various modifications or additions to the preferred embodiments chosen herein to illustrate the present invention, without departing from the spirit of the present invention. Accordingly, it is to be understood that the subject matter sought to be afforded protection hereby should be deemed to extend to the subject matter defined in the appended claims, including all fair equivalents thereof.

### BRIEF DESCRIPTION OF THE DRAWINGS

FIG. 1 shows a structure in the space within three Cartesian axis (X, Y and Z).

FIG. 2 shows the structure of FIG. 1 having a typical representation of a deformation called “buckling”.

FIG. 3 shows the structure of FIG. 1 having a typical representation of a deformation called “torsion”.

FIG. 4 shows a body structure without deformation.

FIG. 5 shows a body structure deformed due to the effects of flexing with respect to the horizontal plane.

FIG. 6 shows a body structure deformed due to the effects of torsion with respect to the horizontal plane.

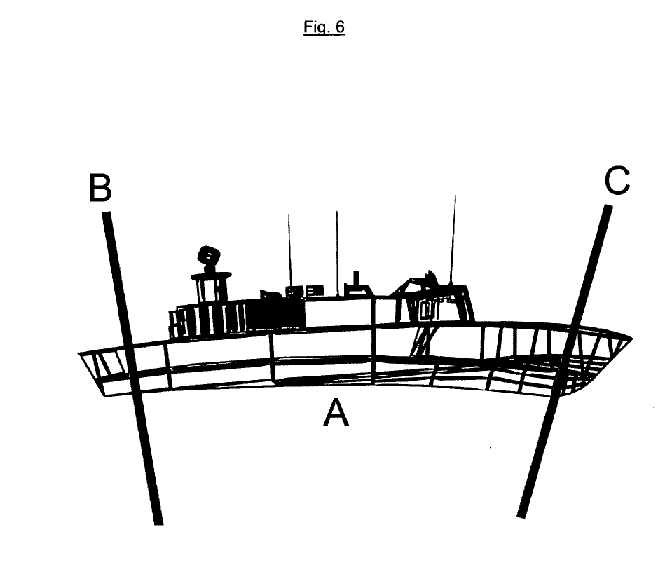

### DETAILED DESCRIPTION OF THE INVENTION

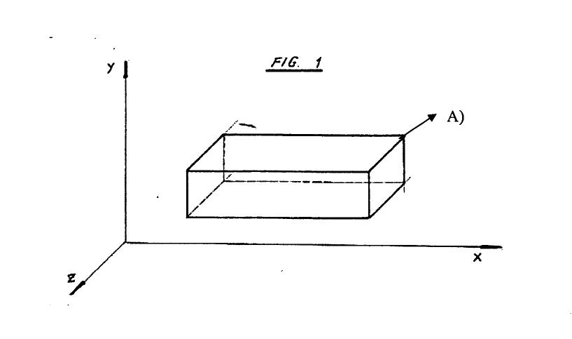

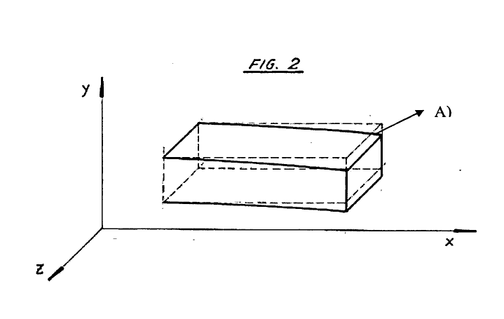

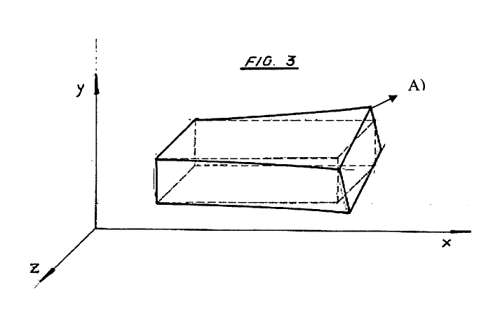

Considering the above, and for a better understanding of the invention that is intended to claim, it is important to take into account that: any volume (structure) is comprised in the space within three Cartesian axis (X, Y and Z) as shown in FIG. 1), when it deforms, the volume A) changes its position in respect of these axis, producing angular changes with respect of the same. For a better example, FIG. 2) shows a typical representation of a deformation called “buckling”. Likewise in FIG. 3) it shows another representation of a typical deformation called “torsion”.

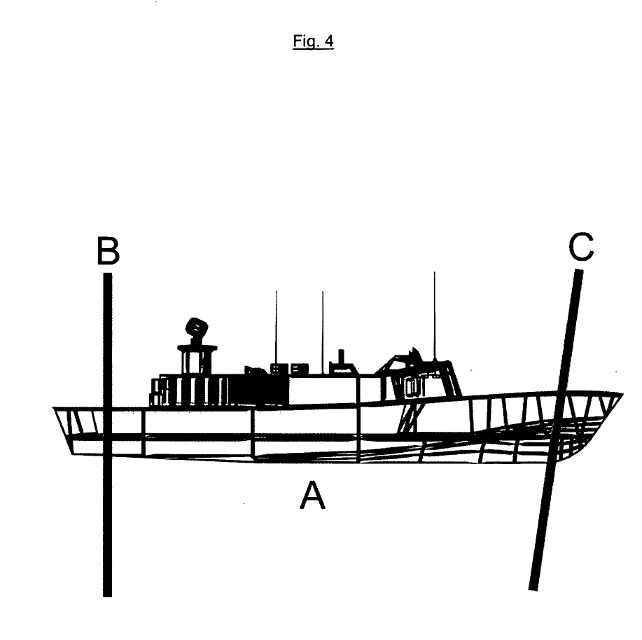

If in the volume of the structure we create a plane with two lines, indicated for these purposes in FIG. 4) B) and C) that follow the direction of the force of gravity, we shall have created an imaginary plane, contained in the structure A) and therefore by the Cartesian axis (x, y, z). For these purposes, and only to give a graphic example of one of the possible applications of the system, an example of a structure of floating type is illustrated, which may correspond to a ship.

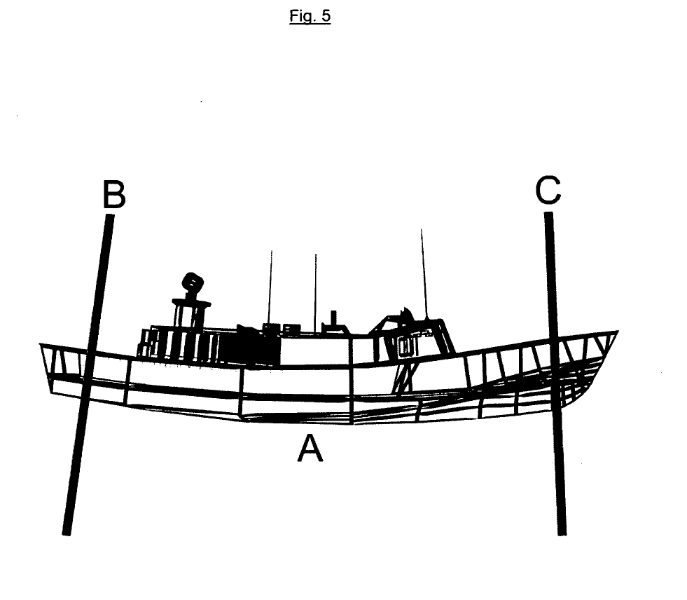

If the body or structure A) deforms, due to the effects of flexing or torsion, this imaginary plane containing lines B) and C) shall be deformed in relation to the plane drawn in the first place. By measuring the angle between the original plane and its new position, we shall have the deformation of the structure A) affected to flexing with respect to the horizontal plane and/or the torsion, see FIGS. 5) and 6).

In order to detect this deformation and in a new system related to the state of the art, the system to be claimed uses sensors (pendulum type and/or inclinometers) which together with the six acceleration values and angular velocity, it is possible to measure an angle with respect to an imaginary plane.

A device shall evaluate the vector composition of the gravity referable with respect of the planes X and Y to evaluate a point of the structure A), which, for the purposes of this specification, it shall be called hereinafter “sensor”. Two or more sensors shall be placed along the structure A) and making interact synchronically with software, the deformation of structure A) is evaluated and the form of the same is drawn.

The larger the number of sensors installed in the structure, the more complete and/or precise shall be the measuring.

The purpose of the software is to integrate the data of sensors synchronically, that are revealing the structure A), to eliminate unusable noises, to record data (in real and historical time), to generate the image or images, to provide information on the degree of deformation produced, the strains under which structure A) is exposed and in the event of having entered limits, to indicate when they are reached.

In spite of a detailed description of the invention, it is important to note that in no way its application is limited to the details and stages described herein. The invention may have other modalities and can be carried out or executed in various ways. It should be noted that the terms used in this description is for descriptive purposes only, not implying limitation.

What is claimed is:

1. A system for measuring, recording, and evaluating a deformation and/or wear of structures and positioning the structures with respect of their axis, the system comprising:
at least one sensor for measuring a vector with respect of planes X and Y, wherein the sensor evaluates a point of a form of the structure;
wherein the at least one sensor is placed over he structure;
wherein the at least one sensor interacts synchronically with a software to integrate a data from the at least one sensor to reveal the form of the structure; and
wherein the at least one sensor evaluates and records the deformation of the structure in order to draw its form.

2. The system of claim 1 wherein the at least one sensor is choose from pendulum, inclinometers, or combination thereof.

3. The system of claim 1 wherein the structure deforms for effects of flexing or torsion to a new position.

4. The system of claim 3 wherein an angle between the original plane and the new position is measure to the find the deformation.

5. The system of claim 4 wherein the angle is measure by measuring acceleration values and an angular velocity.

6. A method for measuring, recording, and evaluating a deformation and/or wear of structures and positioning the structures with respect of their axis, the method comprising:
a) providing a system including at least one sensor;
wherein the at least one sensor is placed over he structure;
b) for measuring a vector with respect of planes X and Y, wherein the sensor evaluates a point of a form of the structure;
c) interacting synchronically the at least one sensor with a software to integrate a data from the at least one sensor to reveal the form of the structure; and
d) evaluating and recording the deformation of the structure in order to draw its form by measuring an angle between the original plane and the new position.
